(19) United States
(12) Patent Application Publication
(10) Pub. No.: US 2026/0246550 A1
(43) Pub. Date: Aug. 20, 2026

(54) Method and Apparatus for Beamforming with Neural Network

(71) Applicant: Telefonaktiebolaget LM Ericsson (publ), Stockholm (SE)

(72) Inventors: Mårten Sundberg, Årsta (SE); David Sandberg, Sundbyberg (SE); Mattias Frenne, Uppsala (SE); Hamed Farhadi, Stockholm (SE); Farshid Ghasemzadeh, Sollentuna (SE)

(21) Appl. No.: 19/480,361

(22) PCT Filed: May 17, 2023
(86) PCT No.: PCT/SE2023/050492

§ 371 Date: Oct. 30, 2025

(51) Int. Cl. H04B 17/391; G06N 3/0895; H01Q 3/26; H04B 7/06; H04B 17/309; H04B 17/336

(52) U.S. Cl. CPC H04B 17/3913; G06N 3/0895; H01Q 3/26; H04B 7/0617; H04B 7/0626; H04B 17/336; H04B 17/347

(57) ABSTRACT

A method (100) for training a beamforming module (401) for a multi-antenna arrangement (300). The beamforming module comprises a neural network adapted to determine beamforming weights for precoding. The method comprises training (102) the neural network of the beamforming module on training data comprising CSI. The method comprises calculating (103) a radiation metric and a beamforming metric as functions of the first set of beamforming weights, applying (104) a first loss function to the radiation metric to obtain a first loss, and applying a second loss function to the beamforming metric to obtain a second loss, calculating (105) a total loss by applying a total loss function to the first loss and the second loss, using backpropagation (106) to compute gradients of the total loss function, and using the gradients to determine a second set of improved beamforming weights.

### TECHNICAL FIELD

The present disclosure is generally related to beamforming and is more specifically related to methods, apparatuses, computer programs, and computer program products for training a beamforming module for a multi-antenna arrangement and calculating beamforming weights for precoding in a multi-antenna arrangement.

### BACKGROUND

For cellular systems to be able to coexist in the same geographical region, certain limitations on the emissions between them are required. Such limitations/requirements are typically put on a transmitter and receiver assuming certain deployments between the potentially interfering systems. The impact of these requirements on system performance are typically studied with pen-and-paper calculations or coexistence studies by simulations.

Traditional requirements relate to e.g. limiting unwanted emissions (such as the ability of a transmitter to limit emissions either in the frequency band of operation or outside of the band), and signal blocking levels (the ability of a receiver to receive a wanted signal while being interfered by a strong unwanted signal).

In early cellular technologies such as Global System for mobile Communications, GSM, 3G, and 4G, these requirements are typically defined conducted, that is, the requirements are tested at the antenna conductor. With more advanced antenna technology, such as massive multiple-input and multiple-output, MIMO, such conducted measurements are no longer possible. In systems using integrated antennas, such antenna conductors are not available. Furthermore, using large antenna arrays means that the directivity of transmission/reception changes aspects related to the coexistence and further changes how to conduct testing that the performance requirements are adhered to. Over-The-Air requirements and testing have been introduced in e.g. 3GPP TS38.104 v 18.0.0 and 3GPP TS38.141-2 v 18.0.0 for advanced antenna systems with the Over-The-Air unwanted emissions requirement limited by total radiated power. However, spatial aspects of unwanted emissions may be introduced at a later stage.

More advanced requirements on advanced antenna system products may for example include requiring that the transmitter comply with certain spatial limitations on emissions, e.g. fulfilling emissions requirements depending on an elevation angle.

Such requirements are under discussion in regulatory forums, but have yet to be introduced in global specifications such as the 3^{rd} generation partnership program, 3GPP. However, they are likely to be introduced with future technologies such as 6G, where spectrum usage and connectivity everywhere are a clearly pronounced focus of the technology.

In the cases where such spatial requirements already exist, they are typically handled on a regional level by regulators for operation in a licensed part of the spectrum, and not by global specifications. Such spatial requirements may for example be introduced in the US, where the Federal Communication Commission, FCC, has taken action to reallocate a portion of the 3.7-4.2 GHz frequency band, making the frequency spectrum from 3.7-3.98 GHz available for 5G networks. In this frequency band, 5G networks may have to introduce new measures in order to coexist with radar altimeters currently operating the globally allocated 4.2-4.4 GHz aeronautical band.

The 5G emissions source that can potentially interfere with radar altimeters can be either in-band emissions or spurious emissions falling within the radar altimeter band.

The 5G in-band emissions may potentially lead to blocking interference in the radio altimeter receiver, for example if a strong signal outside the radio altimeter's bandwidth cannot be sufficiently filtered away. Therefore, depending on the outcome of coexistence studies, it is possible that new regulatory requirements may demand advanced antenna system radios limit elevation effective isotropic radiated power, EIRP, near or inside airports to eliminate any risk of possible harmful interference to radio altimeters, also due to in-band interference. On this basis, mitigation measures are being studied to limit spatial elevation EIRP masks to ensure that mid-band advanced antenna systems products can be configured to operate with controlled elevation beams and envelopes.

### SUMMARY

It is an object of the present disclosure to provide methods and apparatuses for beamforming for a multi-antenna arrangement.

According to a first aspect of the disclosure, there is a computer-implemented method for training a beamforming module for a multi-antenna arrangement. The beamforming module comprises a neural network adapted to determine beamforming weights W for precoding for the multi-antenna arrangement, wherein the multi-antenna arrangement is adapted to establish N communication links with M user equipments, UEs. The method comprises collecting a set of training data points, ϑ. Each of the training data points comprise a channel state information, CSI, for one of the N established communication links between the multi-antenna arrangement and a UE. The set of training data points comprise a CSI for each of the N established communication links. The method further comprises training the neural network of the beamforming module on the training data ϑ, to determine a first set of beamforming weights W₁. The method further comprises calculating a radiation metric f_{R} and a beamforming metric f_{BF} as functions of the first set of beamforming weights. f_{R} is a function evaluating levels of electromagnetic radiation emissions of the multi-antenna arrangement in different spatial directions, and f_{BF} is a function evaluating a communication link quality of each established communication link, for all the N established communication links. The method further comprises applying a first loss function [symbol] to the calculated radiation metric to obtain a first loss associated to the radiation metric, and applying a second loss function [symbol] to the calculated beamforming metric to obtain a second loss associated to the beamforming metric. The methos further comprises calculating a total loss by applying a total loss function to the calculated first loss associated to the radiation metric and the calculated second loss associated to the beamforming metric, where the total loss function is such that finding a global optimal value of the total loss function minimizes the radiation metric and maximizes the beamforming metric. The method further comprises using backpropagation to compute gradients of the total loss function, and using the computed gradients to determine a second set of improved beamforming weights W₂. The method further comprises updating the first set of beamforming weights W₁ of the beamforming module with the second set of improved beamforming weights W₂. Hereby is achieved efficient beamforming with minimal radiation loss.

According to an embodiment of the first aspect, the set of training data points ϑ further comprises information about the multi-antenna arrangement.

According to an embodiment of the first aspect the set of training data points ϑ further comprises information about a mechanical tilt angle of the multi-antenna arrangement.

According to an embodiment of the first aspect, the set of training data points ϑ further comprises information about an electrical tilt angle of the multi-antenna arrangement.

According to an embodiment of the first aspect the set of training data points further comprises information about an emissions mask associated to the multi-antenna arrangement.

According to an embodiment of the first aspect the radiation metric and the beamforming metric are differentiable functions.

According to an embodiment of the first aspect the radiation metric and the beamforming metric further comprise an expected noise variance.

According to an embodiment of the first aspect the beamforming metric further depends on a signal-to-leakage-and-noise ratio.

According to an embodiment of the first aspect the beamforming metric further depends on a signal-to-interference-and-noise ratio.

According to an embodiment of the first aspect the beamforming metric further depends on a signal-to-noise ratio.

According to an embodiment of the first aspect the radiation metric and the beamforming metric further depend on a radiation intensity of the electromagnetic radiation emissions of the multi-antenna arrangement.

According to an embodiment of the first aspect computing gradients of the total loss function, and using the computed gradients to determine/calculate the second set of improved beamforming weights and updating the first set of beamforming weights of the beamforming module with the second set of improved beamforming weights is performed P times, where P≥2.

According to an embodiment of the first aspect computing gradients of the total loss function, using the computed gradients to determine/calculate the second set of improved beamforming weights and updating the first set of beamforming weights of the beamforming module with the second set of improved beamforming weights is iteratively performed until the calculated total loss is below a predetermined threshold.

According to an embodiment of the first aspect the method further comprises computing gradients of the total loss function, using the computed gradients to determine/calculate a second set of improved beamforming weights and updating the first set of beamforming weights of the beamforming module with the second set of improved beamforming weights until, on a validation dataset, the calculated total loss increases with a further computing and updating.

According to an embodiment of the first aspect the set of training data points ϑ is arranged in a set of samples, the set of samples forming mini-batches of training data, wherein the mini-batches are processed in parallel.

According to an embodiment of the first aspect when calculating the total loss, a first weighting factor is associated to the first loss function and a second weighting factor is associated to the second loss function.

According to an embodiment of the first aspect collecting the set of training data points, ϑ, is performed by receiving a CSI report from a user equipment, UE, and providing the CSI report as part of the set of training data points ϑ.

According to an embodiment of the first aspect the CSI report is based on a Type-I codebook.

According to an embodiment of the first aspect the CSI report is based on a Type-II codebook.

According to an embodiment of the first aspect, the method comprises receiving a precoding matrix information, PMI, per sub-band of a transmitted signal from the multi-antenna arrangement.

According to an embodiment of the first aspect the method comprises receiving the PMI as one wideband PMI.

According to an embodiment of the first aspect the method is performed by a network node in a telecommunication network.

According to a second aspect of the disclosure, there is a method for calculating beamforming weights for precoding in a multi-antenna arrangement, wherein the multi-antenna arrangement has access to a trained beamforming module trained according to an embodiment of the first aspect. The method comprises providing a set of possible states of the channel state information, DO, to the trained beamforming module. The method further comprises acquiring beamforming weights from the trained beamforming module based on DO. Hereby is achieved efficiently transmitting information in a communications network while minimizing spatial emissions.

According to an embodiment of the second aspect, the method further comprises applying the acquired beamforming weights for precoding transmissions of the multi-antenna arrangement.

According to an embodiment of the second aspect, the method is performed by a network node in telecommunications network.

According to a third aspect of the disclosure, there is an apparatus comprising a multi-antenna arrangement. The multi-antenna arrangement adapted to establish N communication links with M user equipments, UEs. The apparatus comprises a beamforming module, the beamforming module comprising a memory and a processor. The apparatus is configured to collect a set of training data, ϑ, each of the training data points comprising a channel state information, CSI, for one of the N established communication links between the multi-antenna arrangement and a UE the set of training data points comprising a CSI for each of the N established communication links. The apparatus is configured to train the beamforming module on the training data ϑ, to obtain a trained beamforming module, wherein the beamforming module comprises a neural networks adapted to determine a first set of beamforming weights W for the multi-antenna arrangement. The apparatus is configured to calculate a radiation metric f_{R} and a beamforming metric f_{BF} as functions of the first set of beamforming weights, where f_{R} is a function evaluating levels of electromagnetic radiation emissions of the multi-antenna arrangement in different spatial directions, and f_{BF} is a function evaluating a communication link quality of each established communication link, for all the N established communication links. The apparatus is configured to apply a first loss function [symbol] to the calculated radiation metric to obtain a first loss associated to the radiation metric and apply a second loss function [symbol] to the calculated beamforming metric to obtain a second loss associated to the beamforming metric. The apparatus is configured to calculate a total loss by applying a total loss function to the calculated first loss associated to the radiation metric and the calculated second loss associated to the beamforming metric, where the total loss is such that finding a global optimal value of the total loss function minimizes the radiation metric and maximizes the beamforming metric. The apparatus is configured to use backpropagation to compute gradients of the total loss function, and use the computed gradients to predict a second set of improved beamforming weights and update the first set of beamforming weights of the beamforming module with the second set of improved beamforming weights. Hereby is achieved a beamforming module trained for efficient beamforming minimizing radiation loss.

According to an embodiment of the third aspect the set of training data points further comprises information about the multi-antenna arrangement.

According to an embodiment of the third aspect the set of training data points ϑ further comprises information about a mechanical tilt angle of the multi-antenna arrangement.

According to an embodiment of the third aspect the set of training data points ϑ further comprises information about an electrical tilt angle of the multi-antenna arrangement.

According to an embodiment of the third aspect the set of training data points ϑ further comprises information about an emission mask associated to the multi-antenna arrangement.

According to an embodiment of the third aspect the radiation metric and the beamforming metric are differentiable functions.

According to an embodiment of the third aspect the radiation metric and the beamforming metric further comprise an expected noise variance.

According to an embodiment of the third aspect the beamforming metric further depends on a signal-to-leakage-and-noise ratio.

According to an embodiment of the third aspect the beamforming metric further depends on a signal-to-interference-and-noise ratio.

According to an embodiment of the third aspect the beamforming metric further depends on a signal-to-noise ratio.

According to an embodiment of the third aspect the radiation metric and the beamforming metric further depend on a radiation intensity of the electromagnetic radiation emissions of the multi-antenna arrangement.

According to an embodiment of the third aspect the set of training data points ϑ is arranged in a set of samples, the set of samples forming mini-batches of training data, wherein the mini-batches are processed in parallel.

According to an embodiment of the third aspect when calculating the total loss, a first weighting factor is associated to the first loss function and a second weighting factor is associated to the second loss function.

According to an embodiment of the third aspect the apparatus is further configured to receive a CSI report form a user equipment, UE, and provide the CSI report as part of the training data.

According to an embodiment of the third aspect the CSI report is based on a Type-I codebook.

According to an embodiment of the third aspect the CSI report is based on a Type-II codebook.

According to an embodiment of the third aspect a precoding matrix information, PMI, is received by the apparatus as one PMI per sub-band of a transmitted signal from the multi-antenna arrangement.

According to an embodiment of the third aspect the apparatus is configured to configured to receive the PMI as one wideband PMI.

According to an embodiment of the third aspect the apparatus comprises a radio access node in a telecommunications network.

According to a fourth aspect of the disclosure, there is a radio access network node of a telecommunication network comprising the apparatus of any embodiment of the third aspect. Hereby is achieved efficient beamforming in a telecommunications network.

According to a fifth aspect of the disclosure, there is an apparatus for predicting beamforming weights for precoding for a multi-antenna arrangement, wherein the apparatus has access to a trained beamforming module trained according to an embodiment of the first aspect. The apparatus is configured to provide a set of possible states of the channel state information, DO, to the trained beamforming module, and acquire beamforming weights from the trained beamforming module based on DO. Hereby is achieved a set of beamforming weights for efficient beamforming with minimal radiation loss.

According to an embodiment of the fifth aspect the apparatus comprises a radio access node in a telecommunications network.

According to a sixth aspect of the disclosure, there is a radio access network node of a telecommunication network comprising an apparatus according to an embodiment of the fifth aspect. Hereby is achieved a radio access node for efficient beamforming in a telecommunications network.

According to a seventh aspect of the disclosure, there is a computer program comprising computer program code to be executed by a processor of an apparatus comprising a multi-antenna arrangement and a beamforming module, whereby execution of the program code causes the apparatus to perform operations according to any embodiment of the first aspect.

According to an eighth aspect of the disclosure, there is a computer program product which comprises a computer readable storage medium on which a computer program according to the seventh is stored.

According to a ninth aspect of the disclosure, there is a computer program comprising computer program code to be executed by a processor of an apparatus comprising a multi-antenna arrangement and a beamforming module, whereby execution of the program code causes the apparatus to perform operations according to the second aspect.

According to a tenth aspect of the disclosure, there is a computer program product comprising a computer readable storage medium on which a computer program according to the ninth aspect is stored.

### BRIEF DESCRIPTION OF THE DRAWINGS

FIG. 1a is a flowchart of an embodiment of a method according to the invention.

FIG. 1b is a flowchart of a section of an embodiment of a method according to the invention in FIG. 1a.

FIG. 1c is a flowchart of a section of an embodiment of a method according to the invention in FIG. 1a.

FIG. 1d is a flowchart of a section of an embodiment of a method according to the invention in FIG. 1a.

FIG. 1e is a flowchart of a section of an embodiment of a method according to the invention in FIG. 1a.

FIG. 2 is a flowchart of an embodiment of a method according to the invention.

FIG. 3 is an exemplary antenna according to the invention.

FIG. 4 is an exemplary network node according to the invention.

FIG. 5 is an exemplary communication system according to the invention.

### DETAILED DESCRIPTION OF THE DRAWINGS

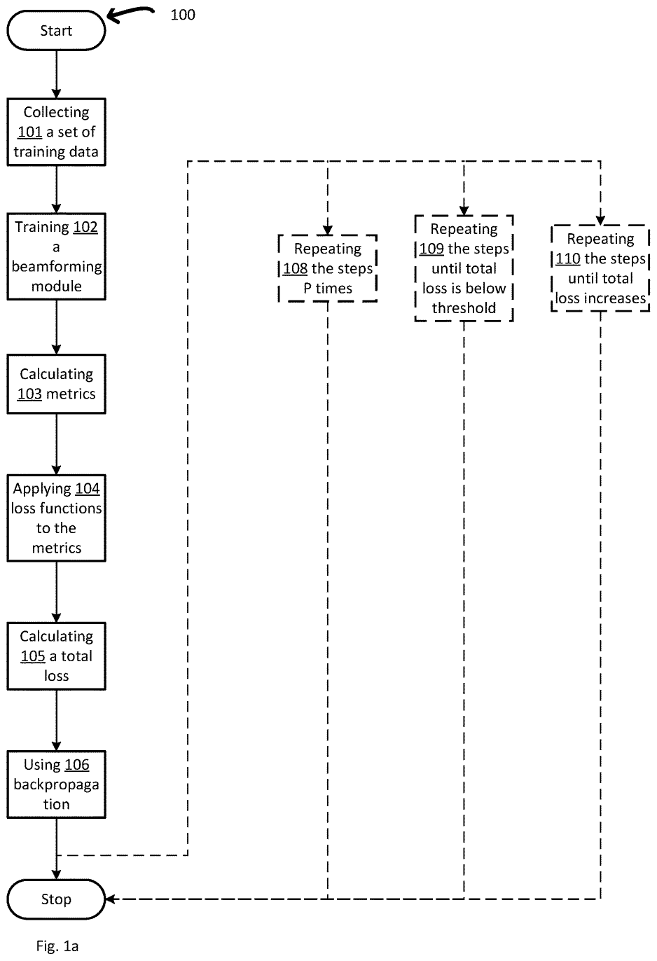

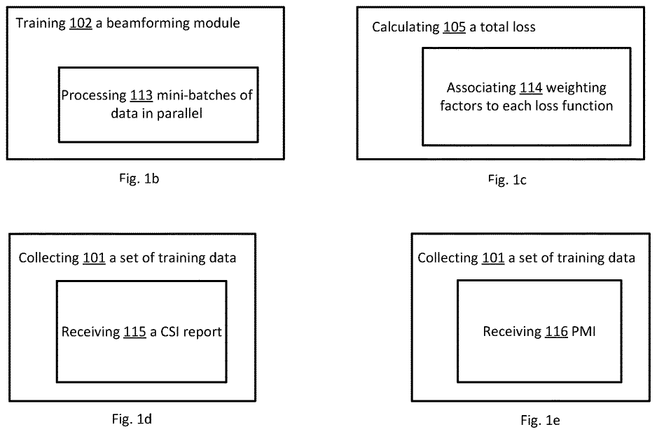

FIG. 1a is a flowchart depicting an instance of a method 100 for training a beamforming module of a multi-antenna arrangement. The purpose of the training is to provide beamforming weights for precoding in the multi-antenna arrangement.

A multi-antenna arrangement is an arrangement of a plurality of antenna elements at a radio access node such as for example a base station, an Evolved Node B, eNB, or a Next Generation Node B, gNB in a communication network. The multi-antenna arrangement can be defined by a set of properties: the antenna element pattern, the number of horizontal antenna elements, the number of vertical antenna elements, the horizontal and vertical distance between antenna elements, and the polarization between each antenna element. In embodiments, the antenna elements are arranged in a uniform planar array, where each column has the same number of elements, each row has the same number of elements, and the spacing between each row and each column is equal. In some embodiments, the elements of the uniform planar array comprise two dual polarized antenna elements.

It will be evident to the person skilled in the art that the concept of an antenna is non-limiting in the sense that the word antenna can refer to any virtualization such as a linear mapping of the elements. For example, the pairs of dual polarized antenna elements above could be fed the same signal, and hence share the same virtualized antenna port.

The beamforming module is a logical entity in the network, implemented by software in a suitable network node. The beamforming module may, in embodiments, comprise a neural network. The beamforming module may be adapted to, in response to receiving input data, predict beamforming weights for the multi-antenna arrangement to use for precoding data. The provided beamforming weights may be predicted so as to comply with spatial emissions masks. The beamforming module may further be adapted to receive input in the form of training data to improve predicted beamforming weights through training.

Training of a neural network, or, more generally, training of a machine learning model generally comprises iteratively updating the parameters of the model in response to additional training data in a way which with high probability will converge towards an optimal value, conditioned on suitable training parameters. Depending on the nature of the function to be optimized to find the optimal value, this optimal value may be a global optimal value or a local optimal value.

In embodiments, the training process may comprise using a backpropagation algorithm to compute gradients of the target function to use to update the parameters.

With reference to FIG. 1a, the method of the disclosure comprises collecting 101 a set of training data points, where the set of training data points may be referred to as ϑ. The set of training data points may be collected through various means, depending on the nature of the training data. In general, the training data may be collected by a network node with access to the relevant data. In some embodiments of the disclosure, the training data may be processed, by the node collecting the training data or a central node, before being used to train the beamforming module.

Each training data points may comprise at least a channel state information, CSI, for one of the N established communication links between the multi-antenna arrangement and a UE. Hence, the set of training data points comprises at least a CSI for each of the N established communication links. The CSI may be estimated by a receiver, such as the UE, and communicated by the UE to the radio access node, or, measured at the radio access node in the reverse direction to where the beamforming module will calculate precoding weights. The latter assumes a reciprocal radio channel. The radio access node may then communicate a set of CSI to the beamforming module, or a central node for further processing before being sent to the beamforming module.

A CSI is the known properties of a communication link. In embodiments of the disclosure, the communication link is an established wireless communication link between the multi-antenna arrangement and a user equipment, UE. In embodiments, the CSI comprises information describing how a signal propagates from the multi-antenna arrangement to the UE and represents the combined effect of, for example, scattering, fading, and power decay due to distance. In embodiments, the CSI is estimated at the UE and fed back to the multi-antenna arrangement to be used as training data. In some embodiments, the CSI may undergo processing before being used as training data.

In some embodiments of the disclosure, the set of training data points ϑ may further comprise information about the multi-antenna arrangement. Information about the multi-antenna arrangement may, for example, be collected when the beamforming module is implemented in the multi-antenna arrangement and updated any time the antenna arrangement is updated. The information about the multi-antenna arrangement may comprise information about an electrical tilt angle of the multi-antenna arrangement. Electrical tilt is an adjustment of the phase of the control signals given to the individual elements of the antenna. The phase adjustment results in a variation of the virtual distance between the antenna back-plate and each antenna element.

Alternatively or in addition, the information about the multi-antenna arrangement may comprise information about a mechanical tilt angle of the multi-antenna arrangement. Mechanical tilt angle refers to an angle of the entire physical antenna arrangement relative to the ground.

Alternatively or in addition, the information about the multi-antenna arrangement may further comprise information about an antenna element radiation pattern. Alternatively or in addition, the information about the multi-antenna arrangement may further comprise information about the antenna element placements.

In some embodiments of the disclosure, the set of training data points may further comprise information about an emissions mask associated to the multi-antenna arrangement. The emissions mask may, for example, be a legal or regulatory mandated emissions mask. The information about the emissions mask may, for example, be provided to the beamforming module when the beamforming module is implemented and updated every time the emissions mask changes. The emissions mask may place limits on emissions in only some spatial directions, or in all spatial directions. The emissions mask may, in embodiments, place different limits on emissions in different spatial directions.

The method further comprises training 102 the neural network of the beamforming module on the training data P in order to obtain a trained beamforming module. The beamforming module may comprise a neural network where the neural network is adapted to determine a first set of beamforming weights W for the multi-antenna arrangement.

The first set of beamforming weights comprises a first prediction for optimal beamforming weights, based on one iteration of the training process.

The method further comprises calculating 103 a radiation metric f_{R} and a beamforming metric f_{BR} as function of the first set of beamforming weights. The radiation metric f_{R} is a function evaluating levels of electromagnetic radiation emissions of the multi-antenna arrangement in different spatial directions.

In some embodiments of the disclosure, the radiation metric and the beamforming metric may comprise differentiable functions.

The radiation metric may, in embodiments, be calculated as an integral of the radiation intensity of the antenna given by the power radiated per solid angle (ϑ, φ). The power radiated per solid angle can be calculated as

$$U ( ϑ , φ ) = \frac{{r}^{2}}{2 η} ( \vert {E}_{ϑ} {\vert}^{2} + {\vert {E}_{φ} \vert}^{2} ) \qquad ( 1 )$$

where E_{ϑ} and E_{φ} are the transverse electric field components in the \hat{ϑ} and \hat{φ} unit directions, η the intrinsic impedance of free space and r the distance from the source.

The radiation metric may consequently be calculated as

$${f}_{R} : = {\int }_{ϑ , φ} U ( ϑ , φ ) . \qquad ( 2 )$$

The skilled person may note that any antenna arrangement could be defined by an associated radiation intensity showing the radiated power distributed over the angular domain. When calculating a composite radiation intensity across multiple antenna ports, the relation between the amplitude and the phase applied to each antenna port will also influence the total radiation intensity, i.e. the beamforming parameters will also influence the final radiation. Hence in embodiments, the radiation metric may be calculated as

$${f}_{R} : = {\int }_{ϑ , φ} U ( ϑ , φ , W ) \qquad ( 3 )$$

for some function g where W is the current calculated beamforming weights.

The radiation metric may further depend on a radiation intensity of the electromagnetic radiation emissions of the multi-antenna arrangement.

The beamforming metric f_{BF} is a function evaluating a communication link quality of each established communication link of the N established communication links.

The beamforming metric may, in embodiments, be calculated as

$${f}_{BF} ( H , W , σ ) = {\sum }_{s = 0}^{{N}_{SB} - 1} {\sum }_{i = 0}^{{N}_{Users} - 1} {g}^{( i )} ( {H}_{s}^{( i )} , {W}_{s}^{( i )} , {σ}_{s}^{( i )} ) \qquad ( 4 )$$

where H is the CSI indexed by channel and sub-band, W is the calculated beamforming weights indexed by channel and sub-band, σ is a noise variance estimate indexed by channel and sub-band, N_{SB} is the number of sub-bands and g⁽ⁱ⁾ is an estimate of the signal-to-interference-and-noise ratio, SINR, at the receiving antenna from the applied beamformer and the experienced CSI. The CSI could, in embodiments, be either the true CSI or an estimate of the CSI depending on what is available to the beamforming module (e.g. training data could be generated by means of a simulation).

In embodiments, the SINR estimate for user i becomes

$${g}^{( i )} = \frac{{‖ {h}^{( i )} {w}^{( i )} ‖}^{2}}{{σ}_{i}^{2} + {\sum }_{i \neq k} {‖ {h}^{( i )} {w}^{( k )} ‖}^{2}} . \qquad ( 5 )$$

The beamforming metric may further comprise an expected noise variance. The beamforming metric may further depend on a signal-to-leakage-and-noise ratio, SLNR. The beamforming metric may further depend on SINR. The beamforming metric may further depend on a signal-to-noise ratio, SNR. The beamforming metric may further depend on a radiation intensity of the electromagnetic radiation emissions of the multi-antenna arrangement.

The method further comprises applying 104 a first loss function [symbol] to the calculated radiation metric to obtain a first loss associated to the radiation metric. The first loss associated to the radiation metric quantifies the extent to which the radiation metric complies with a given emissions mask. An emissions mask defines the allowed emission levels in each spatial direction or in some subset of spatial directions. In an embodiment, such emissions are based on absolute emissions levels of power related to elevation and azimuth angles (i.e. not directly related to the direction of the antenna).

In an embodiment, the first loss function may be defined as [symbol] =Σ_{θ,φ}(C(θ, φ) max(0,f_{R}(θ,φ,W_{Tx})−f_{M}(ω, φ)), where the emissions mask is defined by f_{M}(ϑ,φ) and both f_{M} and f_{R} are defined in the logarithmic domain. The function C(ϑ, φ) constitutes a weighing factor which can weigh different spatial directions differently, depending on the importance assigned to the spatial direction in the emission mask. The overall loss can be computed more efficiently assuming continuous angular directions as

$${ℒ}_{R} = {\int }_{θ = - π}^{π} {\int }_{φ = 0}^{2 π} C ( θ , φ ) \cdot ( max ( 0 , {f}_{R} ( θ , φ , {W}_{Tx} ) - {f}_{M} ( θ , φ ) ) ) d φ d θ .$$

The method further comprises applying a second loss function [symbol] to the calculated beamforming metric to obtain a second loss associated to the beamforming metric.

The second loss function associated to the beamforming metric is simply a measure of the quality of the formed beams and can hence, in embodiments, be calculated by maximizing the SINR or, equivalently, by minimizing [symbol] =−f_{BF}.

The method further comprises calculating 105 a total loss by applying a total loss function to the calculated first loss associated to the radiation metric and the calculated second loss associated to the beamforming metric. The total loss function is, in embodiments, defined such that finding a global optimal value of the total loss function minimizes the radiation loss in accordance with the spatial emission mask and maximizes the SINR.

The total loss function may, in embodiments, be calculated as

$$ℒ = {ℒ}_{R} + {ℒ}_{BF} . \qquad ( 6 )$$

The total loss function is the target function which is maximized or minimized in order to obtain an optimal value of the beamforming weights.

The method further comprises using 106 backpropagation to compute gradients of the total loss function. Backpropagation algorithms are a widely used class of algorithms for training feed-forward neural networks. In particular, backpropagation algorithms efficiently compute the gradient of the total loss function with respect to the current weights of the network in a single input-output step, unlike naïve algorithms which compute the gradient for each individual weight separately. The gradient is calculated by means of the chain rule, computing the gradient one layer at a time, avoiding redundant calculations. This allows for an efficient training process using less computing resources and less memory resources.

The method further comprises using the computed gradients to predict a second set of improved beamforming weights. The computed gradients may be used in an algorithm such as gradient descent or stochastic gradient descent to predict the second set of improved beamforming weights. The second set of improved beamforming weights are improved in the sense that the algorithm using the gradient is mathematically proven to deterministically or with high probability output a prediction which is closer to a global or local optimal value than the first set of beamforming weights. Closer to a global or local optimal value may mean, for example, as measured by applying a suitable norm to a surface defined by the total loss function. Alternatively, closer to a global or local optimal value may mean, for example, as measured by applying a suitable norm to a space which the surface defined by the total loss function is a subspace of.

The method further comprises updating the first set of beamforming weights of the beamforming module with the second set of improved beamforming weights. The second set of improved beamforming weights can now be used for precoding data transmissions from the multi-antenna arrangement to a UE with an established connection to the multi-antenna arrangement. A transmission precoded using the second set of improved beamforming weights is hence closer to complying with a spatial emissions mask while maintaining the quality of the data transmission.

The beamforming module now comprises a neural net for the prediction of beamforming weights for precoding for the multi-antenna arrangement with beamforming weights closer to a global optimal value for beamforming weights, while obeying an emissions mask.

In some embodiments of the disclosure, the method further comprises repeating 108 the training steps. In some embodiments of the disclosure, computing the gradients of the total loss function, and using the computed gradients to calculate the second set of improved beamforming weights and updating the first set of beamforming weights of the beamforming module with the second set of improved beamforming weights is performed P times, where P is some natural number, P≥2. The number of iterations, P, may be predetermined taking into account, for example, the available computing resources, any time constraints on the training process, and predictions based on previous trainings of a beamforming module.

In some embodiments of the disclosure, the training steps of the method may be repeated 109 until the calculated total loss is below a predetermined threshold. In some embodiments, this may be achieved by iteratively using the computed gradients to determine/calculate a second set of improved beamforming weights and updating the first set of beamforming weights of the beamforming module with the second set of improved beamforming weights until the calculated total loss is below a predetermined threshold. The predetermined threshold may be set when the beamforming module is implemented. Such threshold could for example be based on acceptable levels of emissions based on for example regulatory requirements related to the emission loss and a pre-determined acceptable loss for beamforming gain related to the beamforming loss.

In some embodiments of the disclosure, the training steps may be repeated 110 until, when applying the beamforming weights to a validation set of data, the calculated total loss increases with a further computing of the gradients and updating the beamforming weights using the computed gradients, In some embodiments, this may be achieved by iteratively using the computed gradients to determine/calculate a second set of improved beamforming weights and updating the first set of beamforming weights of the beamforming module with the second set of improved beamforming weights until, on a validation dataset, the calculated total loss increases with a further computing and updating. Preferably, the validation set of data is not the same data as used when training the beamforming module. The skilled person will appreciate that the total loss may not decrease monotonously and may thus, for example, apply a suitable function to smoothen the curve for total loss to assess the general trend. It should be noted that, in some embodiments, two or more methods of: repeating the training until the calculated loss function increases, repeating the training P times and repeating the training until the calculated loss is below a predetermined threshold, can be combined.

The skilled person will note that different methods of combining these stopping criteria may be combined, and that the training run for example until any one of them is met.

In some embodiments of the disclosure, the set of training data points ϑ may be arranged in a set of samples. With reference to FIG. 1b, the set of samples may form mini-batches of training data, and the mini-batches can be processed 113 in parallel. Processing the mini-batches in parallel allows for more efficient training of the beamforming module, by for example allowing multiple cores to be used for the computation. Each mini-batch is used to determine partial updated parameters of the model during one epoch of the training period, and the second parameters are taken as a function of the partial updated parameters. In some implementations of mini-batch gradient descent, the second parameters are a weighted average of the partial updated parameters, for example weighted according to the size of each mini-batch.

In some embodiments of the disclosure, when performing the operation of calculating 105 the total loss, the total loss function is calculated (see method step 105 of FIGS. 1a and 1c) as a weighted sum of the loss functions. According to embodiments, the weighted sum is calculated by associating 114 a weighting factor to each loss function, for example a first weighting factor to the first loss function and a second weighting factor to the second loss function. The weighting factors may, for example, be chosen when the beamforming module is implemented, by considering how strict the emissions mask is and how high the reliability requirements are for the particular radio access node. The total loss function may then be calculated as

$$ℒ = α {ℒ}_{R} + ( 1 - α ) {ℒ}_{BF} \qquad ( 7 )$$

for some αϵ(0,1).

With reference to FIG. 1d, in some embodiments of the disclosure, collecting the set of training data points B is performed by receiving 115 a CSI report from a user equipment and providing the CSI report as part of the set of training data points. In, for example, 5G communications systems, the UE receives a channel state information reference signal, CSI-RS, which is used to measure the CSI feedback. The CSI report is then transmitted by the UE to a gNB, where they are used for scheduling downlink data transmissions by for example selecting a modulation scheme, code rate, the number of transmission layers, and, in embodiments of the method of the disclosure, to form part of the training data for a beamforming module.

In some embodiments of the method, the CSI report is based on a Type-I single-panel codebook, as defined in TS 38.214 v.17.4.0, tables 5.2.2.2.1-1 to 5.2.2.2.1-12.

In some embodiments of the method, the CSI report is based on a Type-I multi-panel codebook, as defined in TS 38.214 v.17.4.0, tables 5.2.2.2.2-1 to 5.2.2.2.2-6.

In some embodiments of the method, the CSI report is based on a Type-II codebook, as defined in TS 38.214 v.17.4.0, tables 5.2.2.2.2-1 to 5.2.2.2.3-5.

With reference to FIG. 1e, in some embodiments of the method, receiving the CSI comprises receiving 116 a precoding matrix information, PMI, for each sub-band of a transmitted signal from the multi-antenna arrangement. In other embodiments of the method, receiving the CSI comprises receiving the PMI as one wideband PMI.

In embodiments, any embodiment of the first method may be performed by a network node in a communications network. In some embodiments, the method may be distributed between multiple nodes. Some or all of the nodes performing the method may be virtual nodes.

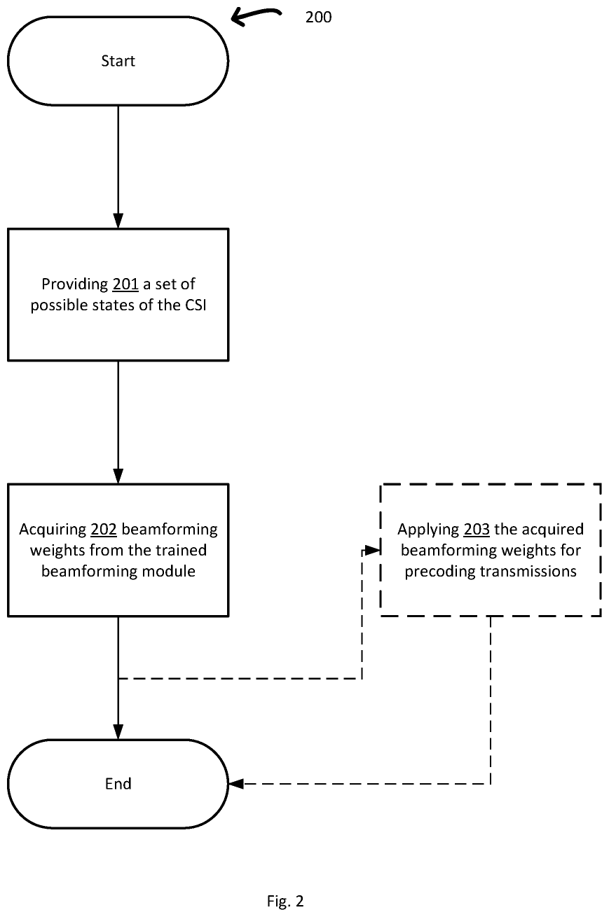

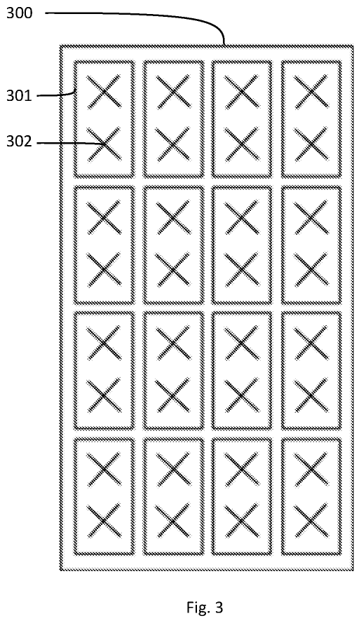

With reference to FIG. 2, there is a second method 200 of the disclosure. The second method is a method for calculating beamforming weights for precoding in a multi-antenna arrangement, where the multi-antenna arrangement has access to a trained beamforming module trained according to the first method of the disclosure. The second method of the disclosure comprises providing 201 a set of possible states of the channel information, Do to the trained beamforming module. The possible states of the CSI may be acquired by a CSI report transmission from the UEs attached to a radio access node.

The second method further comprises acquiring 202 beamforming weights from the trained beamforming module based on Do. The trained beamforming module will, when provided with a set of possible states Do, use the calculated parameters to calculate a set of beamforming weights for precoding, which comply with spatial emissions requirements and provide high quality transmissions.

Embodiments of the second method may further comprise applying 203 the acquired beamforming weights for precoding transmissions of the multi-antenna arrangement.

Applying the beamforming weights may comprise precoding a downlink transmission with the acquired beamforming weights and transmitting it form the multi-antenna arrangement to a UE.

In embodiments, any embodiment of the first method may be performed by a network node in a communications network. In some embodiments, the method may be distributed between multiple nodes. Some or all of the nodes performing the method may be virtual nodes. The method may be performed in a cloud environment. The method may be implemented in an open radio access network, O-RAN, environment.

FIG. 3 depicts an exemplary multi-antenna arrangement 300 for which methods disclosed herein are applicable. The multi-antenna arrangement 300 comprises 16 antenna elements 301, where each antenna element is a dual-polarized antenna elements 302. The exemplary antenna arrangement 300 comprises a uniform planar array, where each column comprises 4 antenna elements, each row comprises 4 antenna elements, and the antenna elements in each row and each column are evenly spaced. The methods of the disclosure may be implemented for other types of antenna arrays, such as non-uniform arrays where the antenna elements are spaced unevenly and/or organized into a configuration other than a grid pattern, or non-planar arrays where the antenna elements are placed on a non-planar surface.

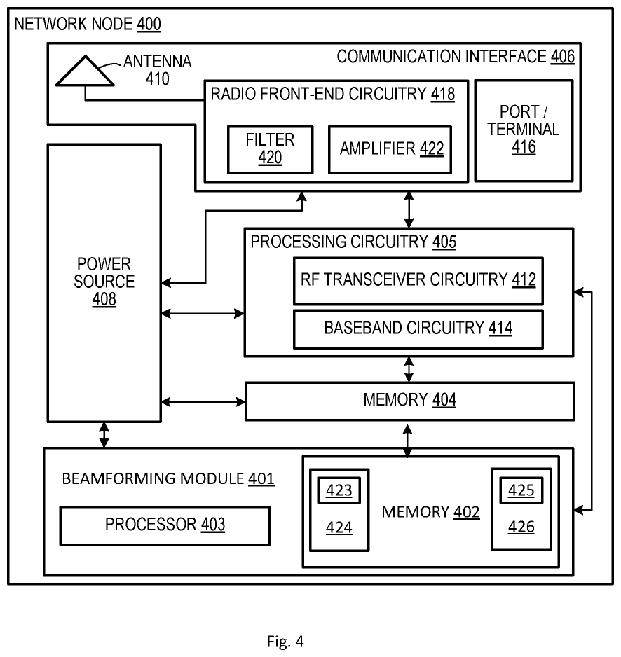

FIG. 4 depicts an exemplary network node 400. In this example, the network node 400 comprises a beamforming module 401. The beamforming module comprises a memory 402 and a processor 403. The processor may be adapted to calculate beamforming weights for the network node according to the second method of the disclosure. Alternatively or in addition, the processor may be adapted to perform the training steps of the first method of the disclosure.

In addition to the beamforming module 401, an exemplary radio access node may comprise a memory 404, processing circuitry 405, a communication interface 406, and a power source 408. The processing circuitry 405 may further comprise radio frequency transceiver circuitry 412 and baseband circuitry 414. The communication interface may further comprise an antenna 410, where the antenna may further comprise a multi-antenna arrangement 300, a port or terminal 416, and radio front-end circuitry 418. The radio front-end circuitry may further comprise a filter 420 and an amplifier 422.

The memory of the beamforming module may further comprise a computer program 423 or a computer program product 424, the execution of which cause the beamforming module to perform a method according to any embodiment of the first method 100. Alternatively or in addition, the memory of the beamforming module may further comprise a computer program computer program 425 or a computer program product 426, the execution of which cause the beamforming module to perform a method according to any embodiment of the second method 200.

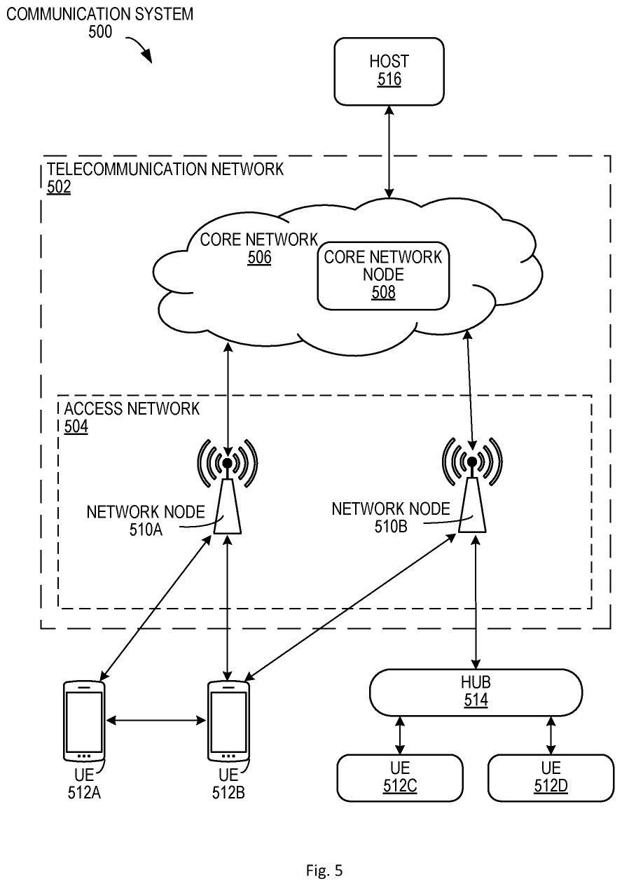

FIG. 5 depicts an exemplary communications system 500 in which the methods of the disclosure may be implemented. Embodiments of the present disclosure are for example applicable for 3G or 4G communications networks, as defined by 3GPP, but may also be relevant for future communication networks such NR, New Radio, also referred to as 5G, 6G or beyond. It may be a public network or a private network. In embodiments, it may be a mixed-type network where some nodes are, for example, 5G nodes, and other nodes are Wi-Fi nodes. The network may comprise a core network 506, which may comprise core network nodes 508. The core network may communicate with a host 516. The network may further comprise a telecommunications network 502 comprising an access network 504, comprising radio access network nodes 510A and 510B. The radio access nodes may communicate directly with UEs 512A 512B. Alternatively or in addition, the radio access nodes may communicate with a hub 514 which in turn communicates, wirelessly or through a wired link, with UEs 512C and 512D.

The methods of the disclosure provide beamforming weights to optimize the wireless links in the communications network with respect to radiation loss, while maintaining signal quality.

1-52. (canceled)

53. A computer-implemented method for training a beamforming module for a multi-antenna arrangement, the beamforming module comprising a neural network adapted to determine beamforming weights W for precoding for the multi-antenna arrangement, wherein the multi-antenna arrangement is adapted to establish N communication links with M user equipments (UEs), the method comprising:
collecting a set of training data points, ϑ, each of the training data points comprising a channel state information (CSI) for one of the N established communication links between the multi-antenna arrangement and a UE, the set of training data points comprising a CSI for each of the N established communication links,
training the neural network of the beamforming module on the training data ϑ, to determine a first set of beamforming weights W₁,
calculating a radiation metric f_{R} and a beamforming metric f_{BF} as functions of the first set of beamforming weights, where f_{R} is a function evaluating levels of electromagnetic radiation emissions of the multi-antenna arrangement in different spatial directions, and f_{BF} is a function evaluating a communication link quality of each established communication link, for all the N established communication links,
applying a first loss function [symbol] to the calculated radiation metric to obtain a first loss associated to the radiation metric, and applying a second loss function [symbol] to the calculated beamforming metric to obtain a second loss associated to the beamforming metric,
calculating a total loss by applying a total loss function to the calculated first loss associated to the radiation metric and the calculated second loss associated to the beamforming metric, where the total loss function is such that finding a global optimal value of the total loss function minimizes the radiation metric and maximizes the beamforming metric,
using backpropagation to compute gradients of the total loss function, and using the computed gradients to determine a second set of improved beamforming weights W₂; and
updating the first set of beamforming weights W₁ of the beamforming module with the second set of improved beamforming weights W₂.

54. A computer-implemented method for calculating beamforming weights for precoding in a multi-antenna arrangement, wherein the multi-antenna arrangement has access to a trained beamforming module, trained according to claim 53, the method comprising:
providing a set of possible states of the channel state information, ϑ, to the trained beamforming module, and
acquiring beamforming weights from the trained beamforming module based on ϑ.

55. An apparatus comprising a multi-antenna arrangement, the multi-antenna arrangement adapted to establish N communication links with M user equipments (UEs), and a beamforming module, the beamforming module comprising a memory and a processor configured to:
collect a set of training data, ϑ, each of the training data points comprising a channel state information (CSI) for one of the N established communication links between the multi-antenna arrangement and a UE the set of training data points comprising a CSI for each of the N established communication links,
train the beamforming module on the training data ϑ, to obtain a trained beamforming module, wherein the beamforming module comprises a neural network adapted to determine a first set of beamforming weights W for the multi-antenna arrangement,
calculate a radiation metric f_{R} and a beamforming metric f_{BF} as functions of the first set of beamforming weights, where f_{R} is a function evaluating levels of electromagnetic radiation emissions of the multi-antenna arrangement in different spatial directions, and f_{BF} is a function evaluating a communication link quality of each established communication link, for all the N established communication links,
apply a first loss function [symbol] to the calculated radiation metric to obtain a first loss associated to the radiation metric and apply a second loss function [symbol] to the calculated beamforming metric to obtain a second loss associated to the beamforming metric,
calculate a total loss by applying a total loss function to the calculated first loss associated to the radiation metric and the calculated second loss associated to the beamforming metric, where the total loss is such that finding a global optimal value of the total loss function minimizes the radiation metric and maximizes the beamforming metric,
use backpropagation to compute gradients of the total loss function, and use the computed gradients to predict a second set of improved beamforming weights and update the first set of beamforming weights of the beamforming module with the second set of improved beamforming weights.

56. The apparatus according to claim 55, wherein the set of training data points further comprises information about one or more of:
the multi-antenna arrangement.
a mechanical tilt angle of the multi-antenna arrangement.
an electrical tilt angle of the multi-antenna arrangement.
an emission mask associated to the multi-antenna arrangement.

57. The apparatus according to claim 55, wherein the radiation metric and the beamforming metric are differentiable functions.

58. The apparatus according to claim 55, wherein the radiation metric and the beamforming metric further comprise an expected noise variance.

59. The apparatus according to claim 55, wherein the beamforming metric further depends on a signal-to-leakage-and-noise ratio.

60. The apparatus according to claim 55, wherein the beamforming metric further depends on a signal-to-interference-and-noise ratio.

61. The apparatus according to claim 55, wherein the beamforming metric further depends on a signal-to-noise ratio.

62. The apparatus according to claim 55, wherein the radiation metric and the beamforming metric further depend on a radiation intensity of the electromagnetic radiation emissions of the multi-antenna arrangement.

63. The apparatus according to claim 55, wherein the set of training data points 9 is arranged in a set of samples, the set of samples forming mini-batches of training data, wherein the mini-batches are processed in parallel.

64. The apparatus according to claim 55, wherein, when calculating the total loss, a first weighting factor is associated to the first loss function and a second weighting factor is associated to the second loss function.

65. The apparatus according to claim 55, further configured to receive a CSI report from a user equipment (UE) and provide the CSI report as part of the training data.

66. The apparatus according to claim 65, wherein the CSI report is based on a Type-I codebook.

67. The apparatus according to claim 65, wherein the CSI report is based on a Type-II codebook.

68. The apparatus according to claim 66, wherein a precoding matrix information (PMI) is received by the apparatus as one PMI per sub-band of a transmitted signal from the multi-antenna arrangement.

69. The apparatus according to claim 66, configured to receive the PMI as one wideband PMI.
